(19) United States
(12) Patent Application Publication
(10) Pub. No.: US 2010/0253720 A1
(43) Pub. Date: Oct. 7, 2010

(54) IMAGE FORMING APPARATUS AND POSITIONING UNIT

(75) Inventors: Nobuaki Takahashi, Shizuoka-ken (JP); Satoshi Kaiho, Kanagawa-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/754,780

(22) Filed: Apr. 6, 2010

Related U.S. Application Data
(60) Provisional application No. 61/167,213, filed on Apr. 7, 2009.

(51) Int. Cl. B41J 25/308; B65H 5/02

(52) U.S. Cl. 347/8; 271/264

(57) ABSTRACT

According to an example of the invention, an image forming apparatus includes, a head mounting section having a head opposed to a medium, a moving section configured to move a conveying section, which is configured to convey the medium, with respect to the head mounting section to come into contact with and separate from the head mounting section, and a positioning mechanism configured to determine positions of the conveying section and the head mounting section through engagement of a head-side engaging section formed in the head mounting section and a conveying-section-side engaging section formed in the conveying section.

### CROSS-REFERENCE TO RELATED APPLICATION

This application is based upon and claims the benefit of priority from: U.S. Provisional Application No. 61/167,213 filed on Apr. 7, 2009, the entire contents of each of which are incorporated herein reference.

### TECHNICAL FIELD

The present invention relates to an image forming apparatus and a positioning unit.

### BACKGROUND

As an image forming apparatus such as an ink-jet recording apparatus, there is known an image forming apparatus in which a conveying unit configured to convey a medium is enabled to move up and down to come into contact with and separate from a head. For example, in JP-A-2008-55631, a roller, a gear configured to transmit driving force, a platen, and a perforated endless belt are provided in a conveying unit that is moved up and down. A motor is provided on a housing side. To secure a space between the gear on the motor side and a shaft on the roller side, the conveying unit performs relative positioning with the head using a positioning shaft section provided near a driving roller and a positioning groove section provided in the housing to which the motor is attached.

In the image forming apparatus, positioning of a head mounting section and the conveying unit is performed by a member different from the head mounting section. Therefore, an error occurs in the positioning of the head mounting section and the conveying unit, ink arrives at a position deviating from a desired position, and a high-quality image is not obtained.

### SUMMARY

According to an example of the invention, an image forming apparatus comprises, a head mounting section having a head opposed to a medium, a moving section configured to move a conveying section, which is configured to convey the medium, with respect to the head mounting section to come into contact with and separate from the head mounting section, and a positioning mechanism configured to determine positions of the conveying section and the head mounting section through engagement of a head-side engaging section formed in the head mounting section and a conveying-section-side engaging section formed in the conveying section.

According to another example of the invention, positioning unit comprises, a head-side engaging section formed in a head mounting section having a head opposed to a medium, and a conveying-section-side engaging section formed in a conveying section, which is configured to convey the medium, and configured to engage in the head-side engaging section, the positioning unit determining positions of the conveying section and the head mounting section through engagement of the head-side engaging section and the conveying-section-side engaging section.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a sectional view of an image forming apparatus according to a first embodiment of the present invention;

FIG. 2 is a sectional view of an image forming section of the image forming apparatus;

FIG. 3 is a plan view of the image forming section;

FIG. 4 is a perspective view of a conveying section of the image forming apparatus;

FIG. 5 is a sectional view of the conveying section of the image forming apparatus;

FIG. 6 is a perspective view of a moving section of the image forming apparatus;

FIG. 7 is a diagram for explaining the operation of a positioning mechanism of the image forming apparatus;

FIG. 8 is a diagram for explaining the operation of the positioning mechanism of the image forming apparatus;

FIG. 9 is a side view of an image forming section of an image forming apparatus according to a second embodiment of the present invention; and

FIG. 10 is a plan view of a conveying section of the image forming section.

### DETAILED DESCRIPTION

### First Embodiment

A first embodiment of the present invention is explained below with reference to the accompanying drawings. In figures, components are enlarged or reduced to be schematically shown or omitted as appropriate. X, Y, and Z indicate three directions orthogonal to one another.

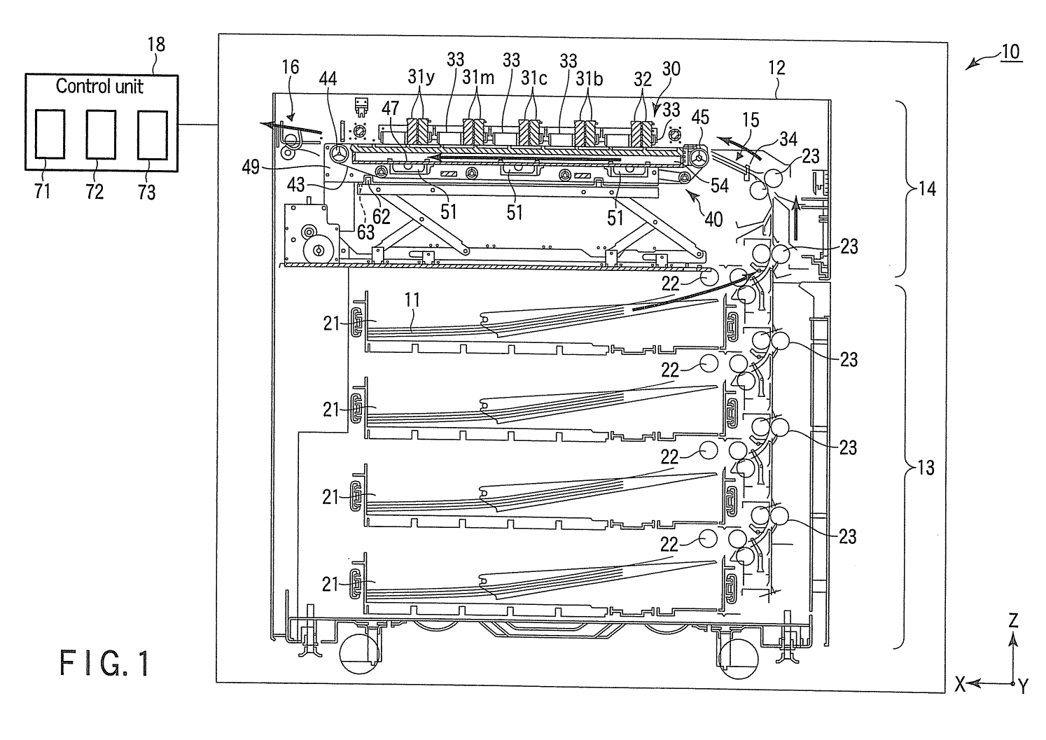

FIG. 1 is a schematic sectional view of an image forming apparatus 10. The image forming apparatus 10 includes an apparatus housing 12 in which components are housed and arranged, a media feeding section 13 configured to feed a medium 11 to an image forming section 14, an image forming section 14 configured to record an image on the medium 11, a conveying path 15 through which the medium 11 passes, a media discharge section 16 configured to discharge the medium 11, a not-shown maintenance section configured to perform maintenance, and a control unit 18 configured to control the operation of the sections.

The media feeding section 13 is provided in a lower part in the apparatus housing 2. The media feeding section 13 includes plural paper feeding trays 21 provided to be superimposed in an up to down direction indicated by a Z axis in the figure, plural pickup rollers 22, and plural feeding roller pairs 23.

Plural media 11 having sizes different from one another are respectively stored in the paper feeding trays 21. The pickup rollers 22 are respectively provided in the paper feeding trays 21. The pickup rollers 22 respectively pick up, one by one, the media 11 at the uppermost positions among the plural media 11 stored in the paper feeding trays 21. The plural feeding roller pairs 23 are provided on a downstream side of the pickup rollers 22. The feeding roller pairs 23 feed the media 11, which are respectively fed from the paper feeding trays 21, to the image forming section 14 along the conveying path 15 according to the rotation of the feeding roller pairs 23.

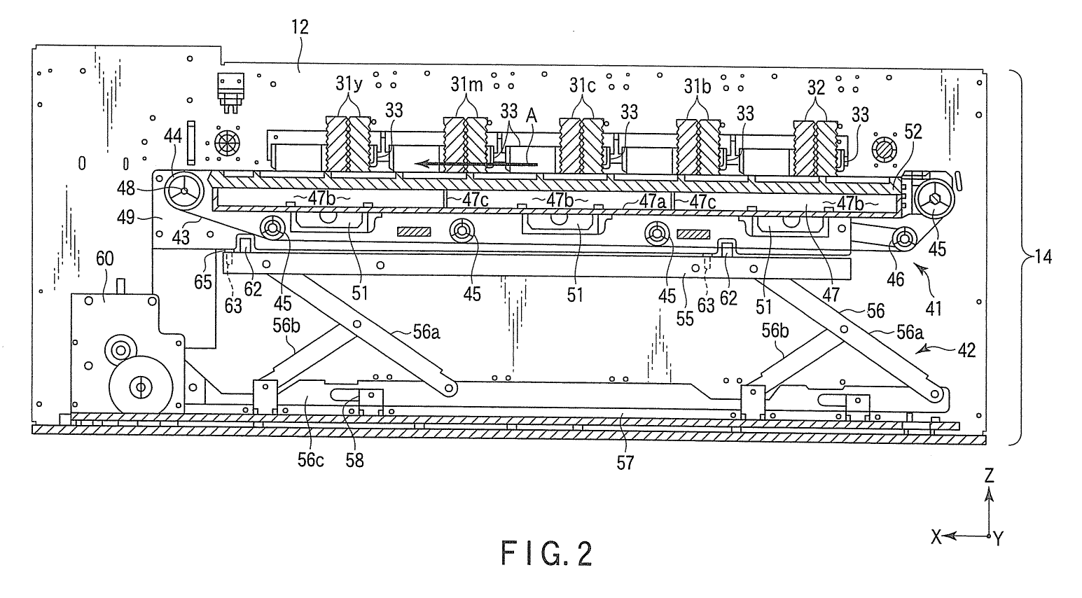

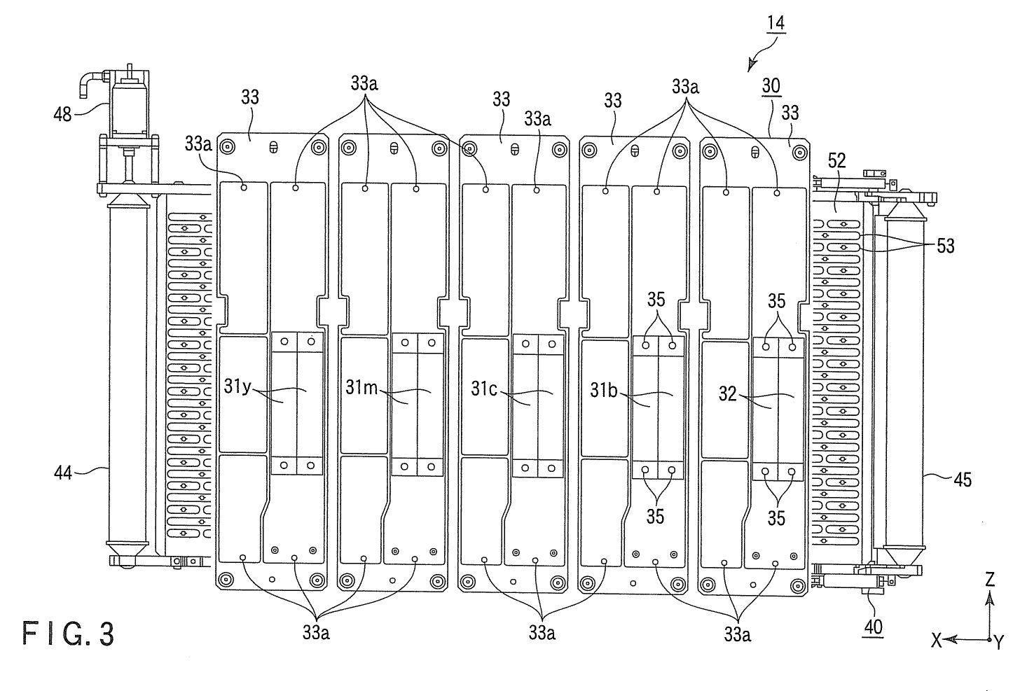

FIG. 2 is a sectional view of the configuration of the image forming section 14. FIG. 3 is a plan view of the image forming section 14. The image forming section 14 is provided in an upper part in the apparatus housing 12 and includes a head mounting section 30, a media conveying unit 40, and a media detection sensor 34 configured to detect a medium.

The head mounting section 30 includes one or plural recording heads 31, the number of which is determined according to an image forming range, resolution, the number of colors, and the like, a pretreatment-liquid supplying head 32, and head bases 33 to which the recording heads 31 and the pretreatment-liquid supplying head 32 are fixed.

In this example, the head mounting section 30 includes, as the recording heads 31, two each of recording heads 31b, 31c, 31m, and 31y for four colors. The plural recording heads 31b, 31c, 31m, and 31y are arranged in parallel in order at every predetermined interval from an upstream side to a downstream side along a conveying direction A of the media conveying unit 40. The recording heads 31b, 31c, 31m, and 31y have plural ejection holes formed in lower surfaces thereof and provided to be opposed to the medium 11 and ejecting mechanisms for ejecting inks from the ejection holes. The ejection holes of the recording heads 31b, 31c, 31m, and 31y respectively eject inks of colors, for example, black (B), cyan (C), magenta (M), and yellow (Y). The recording heads 31 eject the inks from the ejection holes, cause the inks to fly to the medium 11, and form images on the medium 11 conveyed while being opposed to the ejection holes.

The pretreatment-liquid supplying head 32 is provided on an upstream side in the conveying direction A of the plural recording heads 31. The pretreatment-liquid supplying head 32 applies pretreatment liquid to the medium 11. The pretreatment liquid reduces time for fixing the inks on the medium 11. The pretreatment liquid is, for example, a polymer solution such as carboxymethyl cellulose, polyvinyl alcohol, or polyvinyl acetate.

The recording heads 31 and the pretreatment-liquid supplying head 32 are fixed to the head bases 33 by screws 35 incorporating spring washers. The recording heads 31 and the pretreatment-liquid supplying head 32 can be fixed with positions thereof adjusted. Like the heads, the plural head bases 33 include fixing mechanisms by spring washers in order to adjust relative positions thereof.

In the head bases 33 of the head mounting section 30, positioning holes 33a for determining relative positions with respect to a conveying section 41 are provided as head-side engaging sections of positioning mechanisms 20 (positioning units). For example, four positioning holes 33a are provided in two columns and two rows in each of the head bases 33. When the conveying section 41 rises, positioning pins 61 explained later are inserted into the positioning holes 33a upward from underneath according to the rising movement. In other words, the positioning holes 33a function as receiving sections configured to receive the positioning pins 61.

The media conveying unit 40 includes a conveying section 41 configured to convey the medium 11 and a moving section 42 configured to move the conveying section 41 up and down in a Z direction with respect to the head mounting section 30 to bring the conveying section 41 into contact with and separate the conveying section 41 from the head mounting section 30 provided above the conveying section 41.

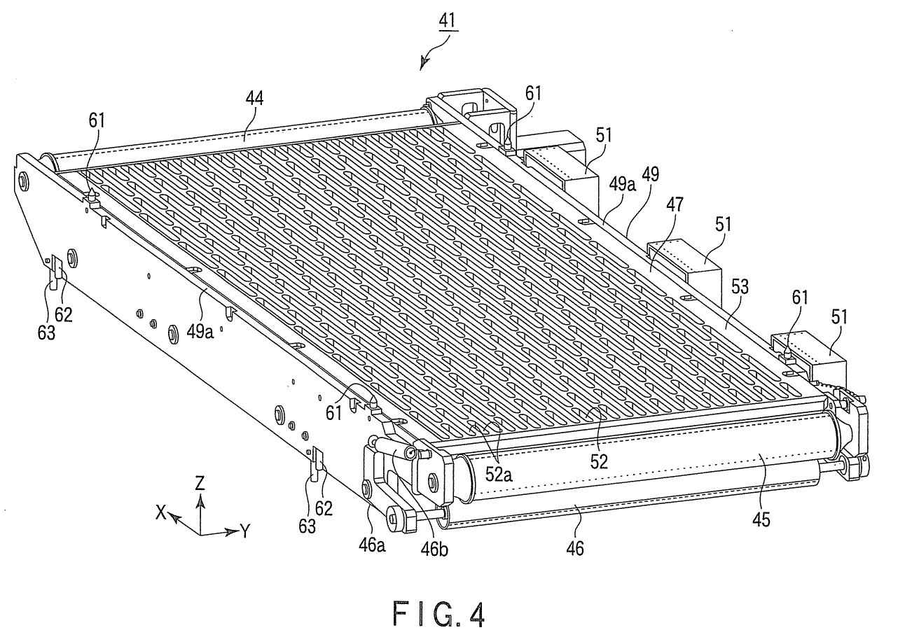

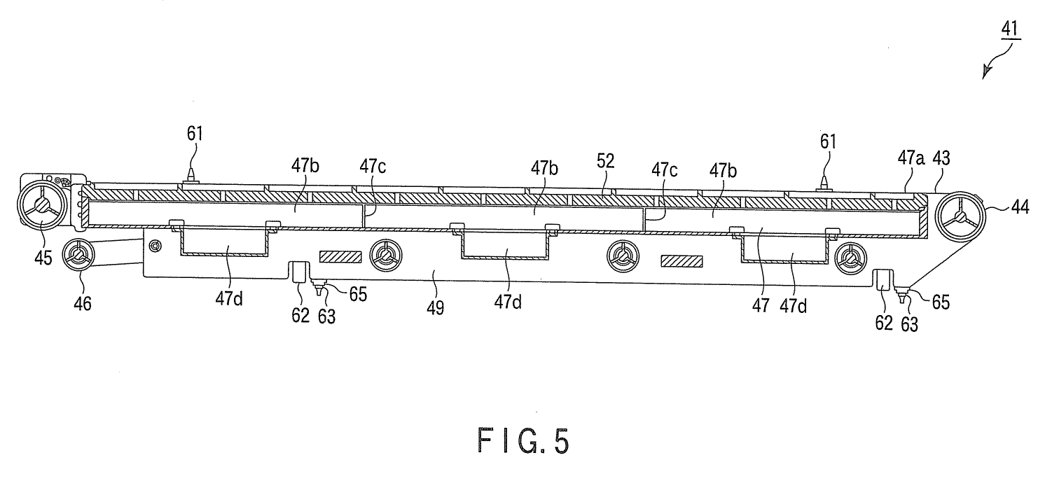

FIG. 4 is a perspective view of the conveying section 41. FIG. 5 is a sectional view of the conveying section 41. The conveying section 41 includes a belt 43 configured to convey a medium, a driving roller 44 configured to drive the belt 43, a driven roller group 45 configured to rotate according to the rotation of the driving roller 44, a tension roller 46 configured to apply appropriate tension to the belt 43, a duct 47 configured to attract the medium to the belt 43, a driving section 48 configured to drive the driving roller 44, and a conveyance housing 49 for integrally housing the members 43 to 48. In order to apply appropriate tension to the belt 43, the conveyance housing 49 includes a tensioner 46a configured to support the tension roller 46 and a tension spring 46b.

The belt 43 is an endless belt manufactured by laminating rubber on fiber and polishing the surface of the rubber. Holes 43a are opened over the entire surface of the belt 43. The belt 43 may be a belt obtained by integrally molding resin such as polyimide or may be a belt obtained by applying end treatment to an ended belt of stainless steel or the like. The roller 44 receives driving force from the driving section 48 and rotates the belt 43 in a desired direction.

The duct 47 includes a frame 47a having a frame member, which surrounds the bottom and the sides of the duct 47, and opened upward. Plural suction spaces 47b partitioned by duct partitions 47c are formed in the frame 47a. Openings 47d are provided in the bottom of the frame 47a. Three attraction fans 51 respectively communicating with the openings 47d are provided on a side of the conveyance housing 49.

A top plate 52 as a supporting member configured to support the rear surface of the belt 43 is provided in an upper part of the duct 47. The top plate 52 is formed in a flat shape and has a large number of holes 52a. The top plate 52 closes the upper sides of the suction spaces 47b formed in the duct 47 and supports the belt 43 in a flat shape. The belt 43 moves in the conveying direction A on the upper surface of the top plate 52. Suction force generated by the attraction fans 51 attracts the medium to a media conveying surface of the belt 43 through the duct 47, the top plate 52, and the holes 43a of the belt 43.

The conveying section 41 configured as explained above causes the belt 43 to travel in a state in which the medium 11 is attracted and positioned on the belt 43 and conveys the medium 11 fed from the media feeding section 13 in the conveying direction A at desired speed.

The positioning pins 61 as conveying-section-side engaging sections of the positioning mechanisms 20 configured to determine a relative position with respect to the head mounting section 30 are provided on the upper surface of the conveyance housing 49 that configures a sidewall of the conveying section 41. The positioning pins 61 are projecting sections configured to project in the Z direction upward in the figure. The positioning pins 61 are respectively provided on the upstream side and the downstream side in the conveying direction on upper surfaces 49a of a pair of sidewalls of the conveyance housing 49 arranged on both sides in a Y direction of the top plate 52 (the width direction of the medium 11).

Relative positions of the head mounting section 30 and the conveying section 41 are determined by the positioning mechanisms 20 including the positioning holes 33a and the positioning pins 61. Specifically, when the conveying section 41 is moved up by the moving section 42, the positioning pins 61 are inserted upward from underneath into the positioning holes 33a, which are provided in the head bases 33 on the upstream side, and engaged in the positioning holes 33a. Consequently, the head bases 33 and the conveyance housing 49 are relatively positioned in predetermined positions.

The positioning holes 33a and the positioning pins 61 are provided on the outer side in the Y direction of the conveying path 15 through which the medium 11 passes. Specifically, between the positioning mechanisms 20 provided on both the sides in the Y direction, the medium 11 moves, through a space between the head bases 33 and the belt 43, from the upstream side to the downstream side along the conveying direction A extending in the X axis direction in the figure between the conveying section 41 and the head mounting section 30.

The positioning pins 61 are provided in, for example, positions corresponding to at least the pretreatment-liquid supplying head 32 most upstream in the conveying direction A and the recording head 31y most downstream in the conveying direction A among the plural heads 31 and 32. According to the upward movement of the conveying section 41, the four positioning pins 61 are respectively inserted upward from underneath into two of the positioning holes 33a provided in the head bases 33 on the upstream side and two of the positioning holes 33a provided in the head bases 33 on the downstream side.

Elastic springs 62 are provided on the lower surface of the conveyance housing 49 of the conveying section 41. The elastic springs 62 are made of elastic members such as leaf springs and configured to be elastically deformable such that lower ends thereof are displaced in the Z direction. When the conveying section 41 is placed on conveyance supporting sections 55, the elastic springs 62 are compressed and bent between the conveying section 41 and the conveyance supporting sections 55 of the moving section 42 and elastically deformed. Consequently, the conveying section 41 is elastically supported in the Z direction with respect to the moving section 42.

Fall preventing pins 63 as projections are provided near the elastic springs 62. The fall preventing pins 63 are formed to project in the Z direction downward from the lower surface of the conveyance housing 49 and tapered. When the conveying section 41 is placed on the moving section 42, the fall preventing pins 63 are inserted into and engaged in fall preventing holes 64 explained later. Consequently, the conveying section 41 is positioned in a predetermined position on the moving section 42.

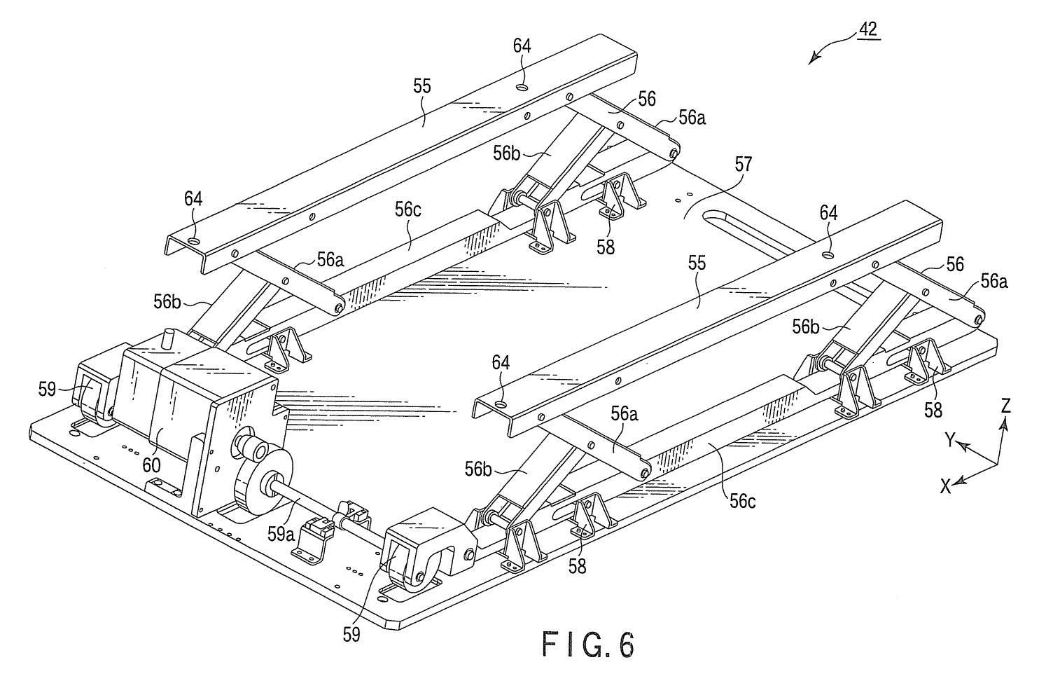

FIG. 6 is a perspective view of the moving section 42. The moving section 42 includes the conveyance supporting sections 55 configured to support the lower surface of the conveying section 41, link mechanisms 56 configured to lift and lower the conveyance supporting sections 55, link supporting stands 57 configured to support the link mechanisms 56, link guides 58 configured to guide a moving direction of the link mechanisms 56, cams 59 configured to drive the link mechanisms 56, cam shafts 59a, and a cam driving section 60 configured to cause the cams 59 to operate.

The link mechanisms 56 include pairs of long arms 56a, short arms 56b, and sub-links 56c pivotably connected to one another. The distal ends of the long arms 56a is pivotably coupled to a pair of conveyance supporting sections 55 extending in the X direction, the long arms 56a and the short arms 56b are pivotably coupled, and the lower ends of the long arms 56a are pivotably coupled to the sub-links 56c. The lower ends of the short arms 56b are pivotably fixed to the link supporting stands 57. When the sub-links 56c move in the X direction according to the rotation of the cams 59, the long arms 56a and the short arms 56b pivot and the conveyance supporting sections 55 move up and down.

The fall preventing holes 64 as recesses are provided in the upper surfaces of the conveyance supporting sections 55 on which the conveying section 41 is placed. The fall preventing holes 64 are provided in positions opposed to the fall preventing pins 63. When the fall preventing pins 63 are inserted into the fall preventing holes 64, the conveying section 41 placed on the moving section 42 is positioned in a predetermined place to regulate movement such as a fall and positional deviation.

Sliders 65 are provided between the fall preventing pins 63 and the fall preventing holes 64.

The sliders 65 are, for example, polyacetal members annularly formed and wound around the pins 63. The sliders 65 are interposed between the lower surface of the conveying section 41 and the upper surface of the moving section 42 to play a role of a lubricant and can prevent friction and abrasion that hinder smooth movement.

A maintenance section includes a cap section for closing the heads 31 and 32, a suction section configured to suck ink purged by the heads 31 and 32, a wiping section configured to wipe ink adhering to the heads after the purge, and a cam mechanism section configured to cause the mechanisms to operate. The maintenance section is moved by a not-shown maintenance driving section and comes into contact with and separates (retracts) from the heads 31 and 32. According to the control by the control unit 18 and on the basis of a predetermined sequence, the maintenance section moves to come into contact with the heads 31 and 32, performs maintenance such as wiping and purge in a state of contact with the heads 31, and retracts after the maintenance ends.

The control unit 18 includes a control section 71 configured to control an operation sequence of the apparatus, an image-formation control section 72 configured to form an image and transmit the image to the heads, and a main control section 73 configured to control motor driving of a mechanism system. The control section 71 performs operation sequence control for the image forming section and the main control section, transmission of image data, and the like. The image-formation control section 72 has a function of converting a transmitted image into a print signal for the heads, transmitting the print signal to the heads 31 and 32, driving the heads 31 and 32 on the basis of the print signal, and causing the heads 31 and 32 to operate to form an image. The main control section 73 is connected to motors and sensors and performs control for causing the units and the sections to perform predetermined operation. The main control section 73 also includes a power supply section for the motors and a driver. The maintenance section and the motors and the sensors as components of the media conveying unit 40 are connected to the main control section 73.

Printing operation of the image forming apparatus 10 is explained below. When an instruction for printing is given from the control unit 18, the maintenance section retracts from a head ejection surface. After the maintenance section retracts from a normal standby (initial) state, the control unit 18 drives the moving section 42 to lift the conveying section 41.

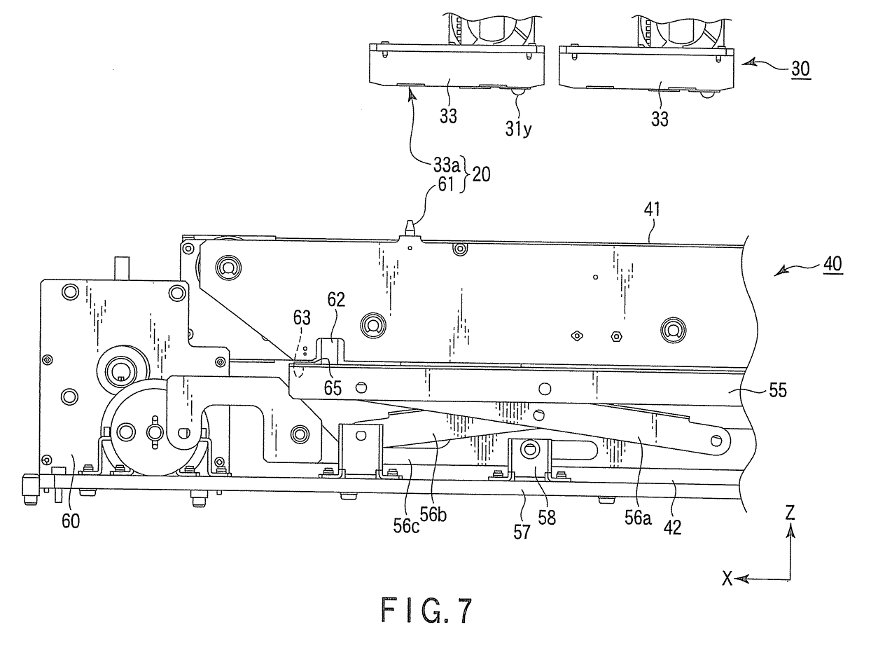

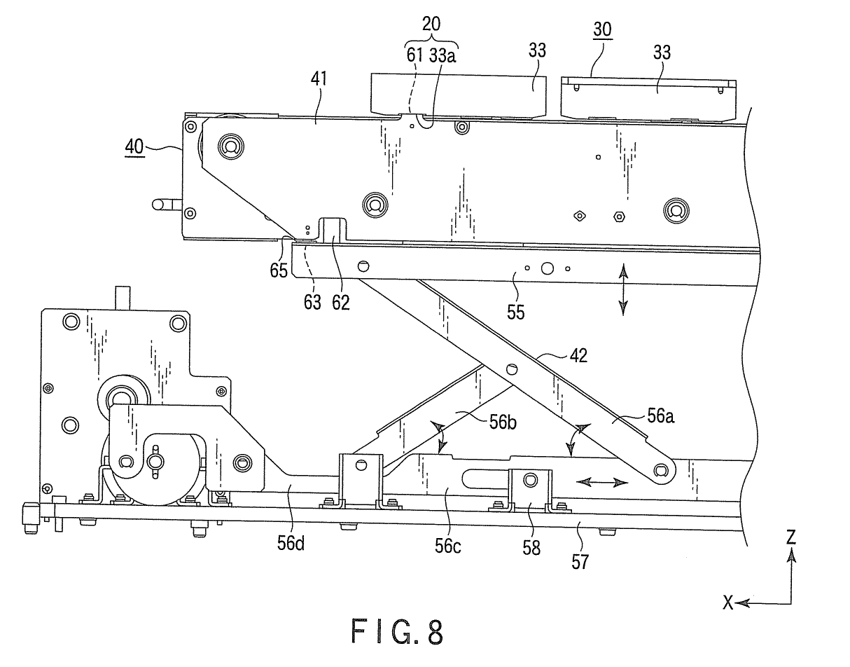

Moving operation for bringing the conveying section 41 into contact with and separating the conveying section 41 from the head mounting section 30 is explained below with reference to FIGS. 7 and 8. The cam driving section 60 rotates in a predetermined direction according to an operation signal of the control unit 18 and the cam shafts 59a and the link driving cams 59 rotate. The sub-links 56c move according to the rotation of the link driving cams 59. At this point, since the movement in the vertical direction is limited by the link guides 58, the sub-links 56c horizontally move in the X direction. According to the horizontal movement of the sub-links 56c, the fulcrums of the long arms 56a translate. The conveyance supporting sections 55 are lifted and lowered by the link mechanisms 56 including the long arms 56a and the short arms 56b, one ends of which are supported. According to the lifting and lowering of the conveyance supporting sections 55, the conveying section 41 moves up and down in the Z direction and comes into contact with or separates from the head mounting section 30 above the conveying section 41.

When the conveying section 41 is lifted by the operation of the moving section 42, the positioning pins 61 of the conveying section 41 are inserted into the positioning holes 33a of the head mounting section 30 and the conveying section 41 and the head mounting section 30 engage with each other. At this point, relative positions in the horizontal direction of the heads 31 and the conveying section 41 are determined by the positioning mechanisms 20 for the positioning pins 61 and the positioning holes 33a.

On the other hand, since the conveying section 41 is elastically supported on the moving section 40 by the elastic springs 62, when the conveying section 41 comes into contact with the head mounting section 30, the elastic springs 62 bend, deform, and come into contact with the conveyance supporting sections 55. At this point, a position in the vertical direction of the head mounting section 30 is determined and relative positions in the vertical direction of the heads 31 and the conveying section 41 are determined.

Thereafter, the medium 11 is picked up from the tray 21 and fed to the media conveying unit 40. When the medium reaches the media conveying unit 40, the medium is attracted by the belt 43 and conveyed along the belt 43. The sensor 34 of the head mounting section 30 detects the passage of the medium and transmits a detection signal to the control unit 18. When predetermined time elapses from the detection signal, the control unit 18 determines that the medium 11 reaches a predetermined position. The heads 31 are driven according to a control signal. The driven heads 31 eject inks and form an image on the medium 11. The medium 11 having the image formed thereon is conveyed to the further downstream side by the belt 43, passes the media discharge section 16, and is discharged to the outside of the image forming apparatus 10 and provided to the user.

When the image formation ends, the moving section 42 falls and the conveying section 41 retracts from the ejecting surfaces of the heads 31 and 32. After the conveying section 41 retracts, the maintenance section performs maintenance on the basis of a predetermined sequence. After the maintenance ends, ejecting surfaces of the heads 31 are capped and closed by the maintenance section and wait for a print instruction, i.e., enter a normal standby (initial) state.

According to this embodiment, effects explained below are realized. Since the positioning holes 33a and the positioning pins 61 as engaging sections are respectively directly formed in the head mounting section 30 and the conveying section 41, it is possible to determine relative positions of the heads 31 and 32 and the conveying section 41. Consequently, since the heads 31 and 32 and the medium 11 are opposed to each other at high accuracy, it is possible to form a high-quality image. When the head mounting section 30 and the conveying section 41 are indirectly engaged via another component, an error occurs in relative positions thereof. However, according to the present invention, it is possible to solve this problem.

Since the positioning mechanisms 20 are provided upstream and downstream of the plural heads, it is possible to efficiently position the heads.

Since the elastic springs 62 are interposed, it is possible to absorb an error in the Z axis direction in mechanism accuracy of the moving section 42 and the head mounting section 30.

Further, since the sliders 65 are interposed, friction and abrasion due to the fall preventing holes 64 for limiting the movement in the Z axis direction of the fall preventing pins 63 and a moving range in the horizontal direction of the fall preventing pins 63 (e.g., scoring and generation of metal powder caused by metal members) are prevented and the fall preventing pins 63 can move smoothly.

### Second Embodiment

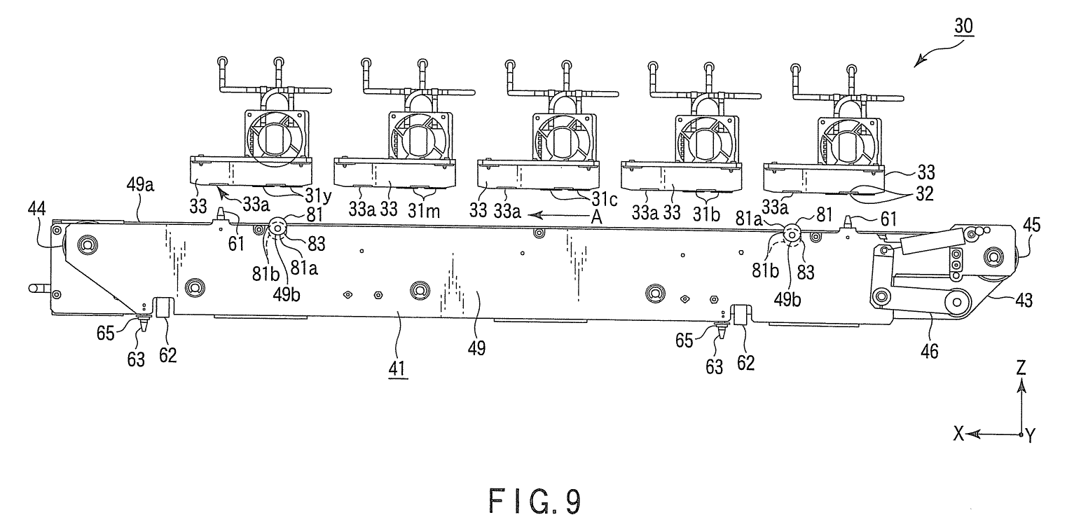

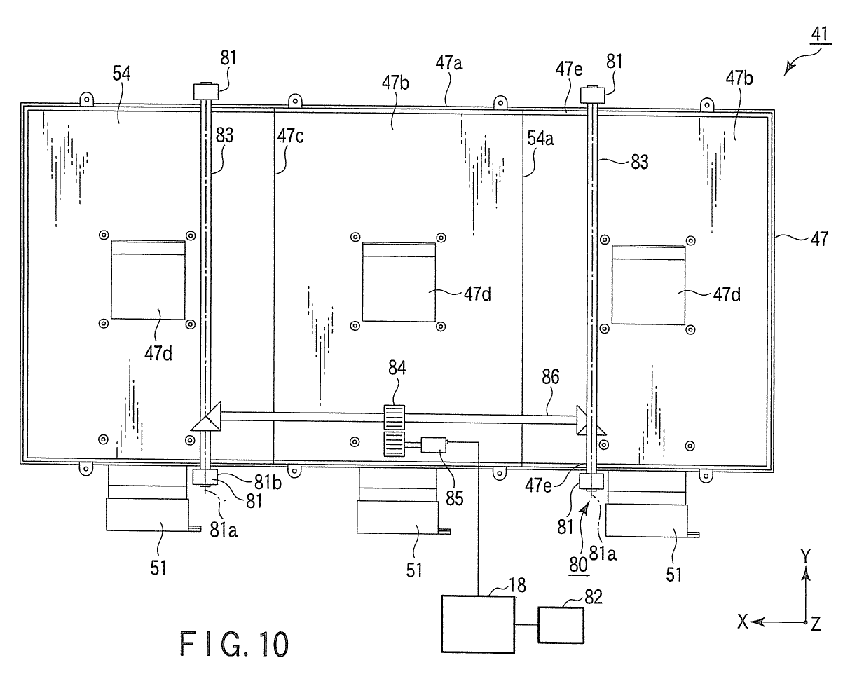

A second embodiment of the present invention is explained below with reference to FIGS. 9 and 10. The image forming apparatus 10 according to the second embodiment is the same as the image forming apparatus 10 according to the first embodiment except that an adjusting mechanism 80 for adjusting a position according to the thickness of a medium is provided. Therefore, common explanation is omitted.

FIG. 9 is a side view of the image forming section 14 of the image forming apparatus 10 according to the second embodiment. FIG. 10 is a plan view of the conveying section 41. In the image forming apparatus 10 according to this embodiment, as the adjusting mechanism 80, adjusting cams 81 provided between the conveying section 41 and the head mounting section 30 and configured to determine an interval, a paper thickness detection sensor 82 configured to detect the thickness of a medium, shafts 83 configured to rotate the adjusting cams 81, an adjusting gear 84 configured to apply driving force to the shafts 83, a driving source for adjustment 85 with a gear configured to rotate according to an instruction from the control unit 18, and a transmission shaft 86 are provided.

The transmission shaft 86 extending in the X direction is coupled via the gear to the driving source for adjustment 85 connected to the control unit 18. The shafts 83 extending in the Y direction are respectively arranged in two places on an upstream side and a downstream side of the transmission shaft 86. The adjusting cams 81 are provided at both ends in the Y direction of the shafts 83. The shafts 83, the driving source for adjustment 85, and the transmission shaft 86 are arranged in the suction space 47b. For example, shaft receiving sections 49b cut out downward are formed in the upper surfaces 49a of the sidewalls of the conveyance housing 49. The shafts 83 are rotatably placed to engage in the shaft receiving sections 49b. The shaft receiving sections 49b are provided adjacent to the positioning pins 61. Upper parts of outer circumferential surfaces 81b of the adjusting cams 81 project further upward than the upper surface of the belt 43. The adjusting cams 81 are arranged between the conveying section 41 and the head bases 33 and on both sides in the Y direction of the conveying path 19, respectively. When the uppermost sections of outer circumferential surfaces 82b of the adjusting cams 81 come into contact with the head bases 33 in a position above the belt 43, positioning in the Z direction of the head mounting section 30 and the conveying section 41 is performed.

The adjusting cams 81 have the outer circumferential surfaces 82b having different distances from rotation axes 81a thereof. Therefore, a distance from the rotation axes 81a of the adjusting cams 81 to the uppermost sections of the outer circumferential surfaces 81b is changed by the rotation of the adjusting cams 81 to make it possible to adjust an interval between the conveying section 41 and the head bases 33 of the head mounting section 30.

The control unit 18 rotates the adjusting cams 81 according to a detection result of the paper thickness detection sensor 82 to adjust the interval between the conveying section 41 and the head mounting section 30. Specifically, it is possible to rotate the adjusting cams 81 with the driving source for adjustment 85 according to a signal from the paper thickness detection sensor 81 corresponding to the thickness of a medium in use and arbitrarily change the position in the vertical direction of the conveyance supporting sections 55.

With the image forming apparatus 10 according to this embodiment, effects same as those of the image forming apparatus 10 according to the first embodiment are obtained. Further, it is possible to change, with the adjusting mechanism 80, the relative height of the conveying section with respect to the heads 31 and 32 according to the thickness of the medium 11.

The present invention is not limited to the embodiments. For example, in the embodiments, an ink ejection type for the heads is an ink-jet type. However, the present invention is not limited to this. For example, a thermal type may be used as the ink ejection type for the heads 31. In the thermal type, a heater is provided in a channel, heat is applied to ink by heating of the heater, and the ink is subjected to film boiling. A pressure change is caused in the ink by growth or shrinkage of air bubbles due to the film boiling. An image is formed on a medium by ejecting the ink from an ejection hole according to the pressure change.

In the example explained in the embodiments, the four types (four colors) of recording heads 31 are provided. However, the present invention is not limited to this. For example, when only the recording head 31b for black is provided, a monochrome image is recorded on the medium. In the example explained in the embodiments, the positioning mechanisms 20 are provided in the heads on the most upstream side and the most downstream side among the plural heads 31 and 32. However, the present invention is not limited to this. For example, as another embodiment, the positioning mechanism 20 may be provided in a position corresponding to the head 31b for black configured to apply black ink that requires higher accuracy.

In the embodiments, the positioning holes 33a are illustrated as the head-side engaging sections and the positioning pins 61 are illustrated as the conveying-section-side engaging sections. However, the present invention is not limited to this. The fall preventing pins 63 are illustrated as the projections and the fall preventing holes 64 are illustrated as the recesses. However, the present invention is not limited to this. The projections and the receiving sections may be reversed or the projections and the recesses may be reversed.

In the example explained in the second embodiment, the distance adjusting mechanism is controlled according to a detection result of the paper thickness sensor configured to detect the thickness of a medium. However, the present invention is not limited to this.

For example, as another embodiment, a registering section configured to register the thickness of a medium according to setting registration by a user may be provided. The control unit 18 may control the distance adjusting mechanism according to a registration result of the registering section.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
a head mounting section having a head opposed to a medium;
a moving section configured to move a conveying section, which is configured to convey the medium, with respect to the head mounting section to come into contact with and separate from the head mounting section; and
a positioning mechanism configured to determine positions of the conveying section and the head mounting section through engagement of a head-side engaging section formed in the head mounting section and a conveying-section-side engaging section formed in the conveying section.

2. The apparatus according to claim 1, wherein one of the head-side engaging section and the conveying-section-side engaging section is a projecting section projecting in a direction of the contact and separation and the other is a receiving section configured to receive the projecting section if the conveying section is moved in a direction in which the conveying section comes into contact with the head mounting section.

3. The apparatus according to claim 2, wherein the head mounting section comprises at least one head and at least one head base configured to fix the head and having the head-side engaging section formed therein.

4. The apparatus according to claim 3, wherein the conveying section comprises:
a belt configured to convey the medium;
a top plate configured to support a lower surface of the belt;
a conveyance housing arranged on a side of the top plate and having the conveying-section-side engaging section formed on an upper surface thereof; and
a duct provided in a lower part of the top plate and configured to attract the belt.

5. The apparatus according to claim 3, wherein
the head mounting section has a pair or more of the heads along a conveying direction in the media conveying section, and
the positioning mechanism is provided in positions corresponding to at least a head most upstream and a head most downstream in the conveying direction among the heads.

6. The apparatus according to claim 3, wherein the positioning mechanism is provided in a position corresponding to the head for black configured to form an image on the medium with black ink.

7. The apparatus according to claim 6, wherein the conveying-section-side engaging section is formed in a position of the media conveying section opposed to the head for black.

8. The apparatus according to claim 2, wherein
the moving section comprises:
a supporting section on which the conveying section is placed; and
a link mechanism coupled to the supporting section and configured to move the supporting section in the contact and separation direction.

9. The apparatus according to claim 2, wherein the head mounting section comprises at least one head and at least one head base configured to fix the head and having the head-side engaging section formed therein.

10. The apparatus according to claim 1, wherein
the head mounting section has a pair or more of the heads along a conveying direction in the media conveying section, and
the positioning mechanism is provided in positions corresponding to at least head most upstream and a head most downstream in the conveying direction among the heads.

11. The apparatus according to claim 1, wherein the positioning mechanism is provided in a position corresponding to the head for black configured to form an image on the medium with black ink.

12. The apparatus according to claim 1, wherein
the conveying section is placed on the moving section, and
an elastic section configured to be elastically deformable and elastically support the conveying section with respect to the moving section is provided between the moving section and the conveying section.

13. The apparatus according to claim 1, wherein
the conveying section is placed on the moving section, and
a projection projecting in the contact and separation direction is provided in one of an upper part of the moving section and a lower part of the conveying section and a recess configured to receive the projection is provided in the other.

14. The apparatus according to claim 7, wherein a lubricating slider is provided between the projection and the recess.

15. The apparatus according to claim 10, further comprising:
a media sensor configured to detect thickness of the medium; and
a control unit configured to adjust distance of between of the head mounting section and the media conveying section according to a detection result of the media sensor.

16. The apparatus according to claim 1, wherein the head is an ink-jet head configured to eject ink or pretreatment liquid to the medium.

17. A positioning unit comprising:
a head-side engaging section formed in a head mounting section having a head opposed to a medium; and
a conveying-section-side engaging section formed in a conveying section, which is configured to convey the medium, and configured to engage in the head-side engaging section,
the positioning unit determining positions of the conveying section and the head mounting section through engagement of the head-side engaging section and the conveying-section-side engaging section.

18. The unit according to claim 17, wherein one of the head-side engaging section and the conveying-section-side engaging section is a projecting section projecting in a direction in which the conveying section comes into contact with and separates from the head mounting section and the other is a receiving section configured to receive the projecting section if the conveying section is moved in a direction in which the conveying section comes into contact with the head mounting section.

19. The unit according to claim 17, wherein
the head mounting section has a pair or more of the heads along a conveying direction in the media conveying section, and
the positioning unit is provided in positions corresponding to at least a head most upstream and a head most downstream in the conveying direction among the heads.
